(19) United States
(12) Patent Application Publication
(10) Pub. No.: US 2025/0125348 A1
(43) Pub. Date: Apr. 17, 2025

(54) CATHODE ACTIVE MATERIAL AND NON-AQUEOUS ELECTROLYTE SECONDARY BATTERY INCLUDING SAME

(71) Applicant: L&F CO., LTD., Daegu (KR)

(72) Inventors: Da Jeong PARK, Daegu (KR); Jun Sung LEE, Daegu (KR); Sung Kyun CHANG, Daegu (KR); Doe Hyoung KIM, Daegu (KR)

(21) Appl. No.: 18/685,266

(22) PCT Filed: Aug. 31, 2022
(86) PCT No.: PCT/KR2022/013068

§ 371 Date: Feb. 21, 2024

(30) Foreign Application Priority Data
Sep. 3, 2021 (KR) 10-2021-0117651

(51) Int. Cl. H01M 4/525; H01M 4/02

(52) U.S. Cl. CPC H01M 4/525; H01M 2004/021

(57) ABSTRACT

Disclosed is a cathode active material for a non-aqueous electrolyte secondary battery, wherein, when comparing volume versus particle size distribution (PSD) graphs before and after pressing under the following pressing condition, the condition of the following Equation 1 is satisfied at point A corresponding to a diameter of particles having a maximum occupied volume before pressing on an X-axis of the graph.

$$[ Equation 1 ]$$

$$Z = ( volume \% of particles at point A after pressing / volume \% of particles at point A before pressing ) \times 100$$

$$Z \geq 85 \%$$

[Pressing Condition]

The active material is pressed at 4.5 tons per unit area (cm²).

### TECHNICAL FIELD

The present invention relates to a cathode active material and more particularly, to a cathode active material that exhibits excellent battery characteristics by satisfying specific particle diameter and volume distribution conditions before and after pressing in a secondary battery manufacturing process, and a non-aqueous electrolyte secondary battery including the same.

### BACKGROUND ART

Lithium secondary batteries are widely used in various fields such as mobile devices, energy storage systems, and electric vehicles, and require high operating voltage, capacity, lifespan characteristics, and improved stability. Also, high energy density has the greatest impact on performance of lithium secondary batteries. Energy density is an essential factor in determining the performance of a battery or electrode, and refers to an amount of energy (charge) stored per unit weight or unit volume (Wh/kg, Wh/L).

In the process of manufacturing such a lithium secondary battery, “pressing” is required, which involves mixing raw materials such as a cathode active material, a binder, and a conductive material, and then pressing the resulting mixture at a predetermined pressure using a device such as a roll-press in order to improve energy density. This process is required to increase the capacity density of the electrode and increase the adhesion between the current collector and the active material.

However, the high pressure applied during pressing may cause the problem of breakage of the particles of the cathode active material, which is one of the main causes of deterioration of battery characteristics.

Specifically, a general lithium secondary battery uses a non-aqueous electrolyte, which typically contains a lithium salt and a carbonate-based organic solvent. The electrolyte penetrates into the micropores of the electrode and functions to supply lithium ions and exchange the lithium ions at the interface with the active material. The cathode active material receives lithium from the electrolyte and involves oxidation/reduction inside the structure.

During oxidation/reduction, lithium is intercalated/deintercalated, thus causing structural changes. As this cycle progresses, structural collapse occurs and irreversibility increases. In particular, when the cathode active material exists in the form of broken particles and small fine powders due to the pressing process, the surface area of the cathode active material exposed to the electrolyte increases, causing greatly increasing reactivity with the electrolyte and side reactions. Such side reactions yield HF or LiF, which accelerates gas generation, resulting in expansion of battery cells, or forms a solid electrolyte interphase (SEI) layer, resulting in rapid reduction of electrochemical properties.

Therefore, there is an increasing need to develop a cathode active material that can solve these problems.

### DISCLOSURE

### Technical Problem

Therefore, the present invention has been made to solve the above and other technical problems that have yet to be solved.

Therefore, as a result of extensive research and various experiments, the present inventors tracked changes in active material particles before and after pressing, especially changes in diameter and volume distribution of active material particles during the secondary battery manufacturing process in various aspects and found that excellent battery characteristics can be obtained when these factors satisfy the specific conditions. Based on this finding, the present invention was completed.

### Technical Solution

In accordance with an aspect of the present invention, provided is a cathode active material for a non-aqueous electrolyte secondary battery, wherein, when comparing volume versus particle size distribution (PSD) graphs before and after pressing under the following pressing conditions, the condition of the following Equation 1 is satisfied at point A corresponding to the diameter of the particles having a maximum occupied volume before pressing on the X-axis of the graph.

$$[ Equation 1 ]$$

$$Z = ( volume \% of particles at point A after pressing / volume \% of particles at point A before pressing ) \times 100$$

$$Z \geq 85 \%$$

### [Pressing Condition]

The active material is pressed at 4.5 tons per unit area (cm²).

As described above, when the active material powder is pressed in the process of preparing a cathode active material, the particles are broken by the applied pressure and thus change in volume.

Specifically, since a cathode active material having a secondary particle structure has an aggregated structure of primary particles, the weakly bonded primary particles are desorbed or the secondary particles are broken into several fragments, and thus the number of relatively small particles increases.

The cathode active material present as a non-aggregated single particle has a single particle structure rather than an aggregated structure, and thus exhibits excellent durability during pressing compared to the secondary particle structure. Therefore, preferably, the cathode active material of the present invention may include non-aggregated one-body particles.

However, although the cathode active material contains non-aggregated one-body particles, some particles are weakly aggregated due to technical limitations, and these weakly aggregated particles are desorbed or one-body particles are broken into several fragments when pressed, resulting in an increase in number of relatively small particles.

In this case, the phenomenon in which, not only particles that are substantially broken, but also particles that are weakly bound/aggregated are desorbed by pressing constitute particle breakage, and the term “particle breakage” hereinafter refers to both of these cases. Both the particles that are broken and are split into several fragments, and the small particles that are weakly bound/aggregated and then desorbed are defined as fine powder. In other words, the fine powder refers not only to particles with a small diameter, but also to particles whose size has been reduced by pressing. In addition, the criteria for the size of the fine powder are not absolute but relative.

According to the present invention, when comparing the volume distribution of particles before and after pressing in the process of pressing based on a particle size distribution (PSD) graph, excellent battery characteristics were achieved by applying a cathode active material that satisfies the conditions of Equation 1 to a non-aqueous electrolyte secondary battery.

Data analysis of the PSD graph for the volume distribution of particles is based on the following factors.
Diameter (D): Diameter of a specific particle
Volume (D³): Volume of a specific particle
Number (n): Number of particles with a specific particle size
Occupied volume (O): Volume (D³)×Number (n)
Number %: Number of particles with a specific diameter (D) (n)/Total number of particles×100
Volume %: Occupied volume (O) of particles with a specific diameter (D)/total occupied volume of all particles×100
D50: Particle diameter at 50% of cumulative volume

As described above, particles having the maximum occupied volume refer to particles having the maximum value (occupied volume) when multiplying the volume calculated from a diameter by the number of particles having the diameter. Therefore, although the number of particles is the largest, if each particle has a very small volume, the particles may not correspond to particles having a maximum occupied volume. On the other hand, although the number of particles is relatively small, if each particle has a large volume, the particles may correspond to particles having a maximum occupied volume. Generally, D50 is set as a parameter of an average particle diameter in PSD analysis. D50 refers to a particle diameter corresponding to a cumulative volume of 50% with respect to the total volume (%) of all particles and does not mean that the number of the particles having the corresponding volume are the largest. As such, D50 and occupied volume have different meanings, and thus the diameter with the maximum occupied volume may or may not be equal to the D50 diameter depending on the particle size distribution of the powders. That is, the particle has the highest volume % at the diameter of particles having the maximum occupied volume (point A), but the diameter of particles having the highest volume % (point A) does not mean D50. Therefore, Z satisfying the condition of Equation 1 above does not mean a D50 variation before and after pressing.

Based on this, according to the present invention, in the PSD data analysis before pressing, the position on the X-axis of the PSD graph corresponding to the diameter of the particles with the maximum occupied volume is specified as “point A”, and it is determined whether or not the degree to which the particle volume at point A changes (Z) after pressing satisfies the conditions of Equation 1.

Therefore, Z in Equation 1 is interpreted to mean “occupied volume retention rate before and after pressing of particles having the maximum occupied volume” (hereinafter referred to as “maximum occupied volume retention rate”). Specifically, as Z becomes close to 100%, the particle strength is high and volume change is less (retention rate is high), and as Z becomes far from 100%, the particle strength is low and volume change is high (retention rate is low). Therefore, when the particle strength is high, the maximum occupied volume retention rate increases because the number of broken particles is small, and when the particle strength is low, the maximum occupied volume retention rate decreases because the number of broken particles increases. This increase in particle strength can be achieved by changing various reaction conditions in the process of preparing the cathode active material, for example, by changing the calcination temperature, calcination time, Li-metal ratio, and the like, as shown in the experimental examples described later, but are not limited thereto.

In one specific example, Z, the maximum occupied volume retention rate, may be 85% or more and 100% or less, and an example of Z can be seen from the graph of FIG. 1.

As can be seen from FIG. 1, the particle having the maximum occupied volume before pressing decreases in volume while maintaining almost the same diameter after pressing at ‘point A’. As a result, Z, the maximum occupied volume retention rate, exceeds 85%, providing high particle strength and excellent battery characteristics, especially high lifespan retention rate, low lifespan resistance increase rate and low gas generation rate during repetitive charging and discharging. However, as shown in FIG. 3, when Z exceeds 100%, characteristics deteriorate compared to when Z is 100% or less. In this case, characteristics deterioration may decrease under appropriate conditions.

On the other hand, the graph of FIG. 2 shows an example in which Z, the maximum occupied volume retention rate, is less than 85%. As can be seen from FIG. 2, the particles having the maximum occupied volume before pressing have reduced diameter and volume after pressing, resulting in the maximum occupied volume retention rate, Z, being less than 85%. Such a cathode active material is not preferred due to the difficulty in providing excellent battery characteristics.

For reference, the pressing may be performed using, for example, Autopellet 3887NE.L from Carver.

In one specific example, the cathode active material according to the present invention may satisfy the condition of Equation 2 below.

$$[ Equation 2 ]$$

$$Y = ( diameter of particles having a maximum \text{} occupied volume after pressing / diameter of particles having a maximum occupied volume before pressing ) \times 100$$

$$Y \geq 80 \%$$

In addition, the degree to which the diameter of the particles having the maximum occupied volume before pressing is maintained after pressing (hereinafter referred to as “maximum occupied volume diameter retention rate”) is preferably a predetermined level or higher.

The result of in-depth analysis by the present applicant showed that, when Equation 1 is satisfied and Y, the maximum occupied volume diameter retention ratio, is 80% or more, battery characteristics are further improved.

Referring to FIG. 3 in relation to the conditions of Equation 2, the cathode active material of FIG. 3 satisfies the condition of Y (maximum occupied volume diameter retention rate) of 80% or more, and at the same time, the condition of Z (maximum occupied volume retention rate) exceeding 100%. When the particles are broken by pressing, Z may exceed 100% depending on the size of broken particles. In this case, particles having the maximum occupied volume before pressing have a decreased diameter and increased volume after pressing.

The maximum occupied volume retention rate exceeds 100% because the particles having the maximum occupied volume before pressing are broken by pressing and the number of particles having the corresponding diameter decreases, but the particles broken by pressing have a specific relatively small diameter. Particle breakage is generally undesirable, but excellent characteristics can be obtained if the size shift is within a limited range, although these characteristics are low than when Z satisfies 85% to 100%.

However, it is not preferable that the particles are broken into small fragments with a size of 1 μm or less due to low particle strength, the fine powder increases rapidly and the maximum occupied volume retention rate exceeds 100%.

In another specific example, the cathode active material according to the present invention may satisfy the conditions of Equation 3 below.

$$[ Equation 3 ]$$

$$W = ( volume \% of newly observed peak in a small particle area after pressing / volume \% of particles at point A before pressing ) \times 100$$

$$W \leq 10 \%$$

wherein the small particle area is an area where a particle diameter is 1 μm or less.

An example related to the conditions of Equation 3 above will be described with reference to FIG. 4. It can be seen from FIG. 4 that a peak not observed in the small particle area (for example, 1 m or less) before pressing is newly observed after pressing. This is because the occupied volume of small particles increases as the particles are broken by pressing. This results from the fact that particles having a low particle strength are broken into small fragments.

When the particle size decreases as the particles are broken, the degree of deterioration in battery characteristics may vary depending on the size of broken particles. As shown in FIG. 4, when the occupied volume of small particles greatly increases, the battery characteristics may be greatly deteriorated. Therefore, the occupied volume increase rate of the peak newly observed in the small particle region after pressing is preferably within a predetermined range. The result of in-depth analysis by the present inventors showed that, when the occupied volume increase rate of the newly observed peak exceeds 10%, the battery characteristics rapidly deteriorate.

Preferably, the cathode active material according to the present invention is applied to non-aqueous electrolyte secondary batteries. As described above, a cathode active material with high particle strength that satisfies the condition of Z (maximum occupied volume retention rate) as defined above, preferably in addition to the condition of Y (maximum occupied volume diameter retention rate) and the condition of W (small particle occupied volume increase rate) during pressing at a high pressure in order to increase energy density can exhibit superior characteristics when applied to a non-aqueous electrolyte secondary battery.

As described above, the cathode active material according to the present invention may preferably include non-aggregated one-body particles, and the average particle diameter (D50) of the cathode active material may be, for example, in the range of 2 to 10 μm.

The secondary particle structure has a relatively high probability of breaking along the primary particle interface when pressed because the primary particles have an aggregated structure, whereas the non-aggregated one-body structure has a higher particle strength because it is composed of a single particle.

In one preferred example, the cathode active material may have a non-aggregated one-body particle structure and satisfy the condition of Equation 1 that Z is 90% or more. Similarly, it is more preferable that the cathode active material satisfy the condition of Equation 2 that Y is 90% or more and/or the condition of Equation 3 that W is 5% or less or 1% or less. This means that the maximum occupied volume retention rate (Z) and the maximum occupied volume diameter retention rate (Y) before and after pressing are very high, and the occupied volume increase rate (W) at the newly observed peak in the small particle region is very low. It can be seen from the experimental details described later that better characteristics can be obtained.

The elemental composition of the cathode active material according to the present invention may be represented, for example, by the following Formula (4).

LiₐM_{b}D_{c}Oₓ (4)
wherein
M includes at least one of Ni, Co, and Mn,
D includes at least one selected from alkali metals excluding lithium, alkaline earth metals, transition metals in Groups 3 to 12 excluding nickel, cobalt and manganese, post-transition metals and metalloids in Groups 13 to 15, and non-metallic elements in Groups 14 to 16, and
a, b, c and x satisfy 0.9≤a≤2.0, 0<b≤1, 0≤c≤0.5, and 0<x≤8, respectively.

The alkali metal other than lithium may be, for example, Na, K, Rb, Cs, Fr, or the like, the alkaline earth metal may be, for example, Be, Mg, Ca, Sr, Ba, Ra, or the like, the transition metal of Groups 3 to 12 excluding and nickel, cobalt, and manganese may be, for example, Sc, Ti, V, Cr, Fe, Cu, Zn, Y, Zr, Nb, Mo, Tc, Ru, Rh, Pd, Ag, Cd, Hf, Ta, W, Re, Os, Ir, Pt, Au, Hg, or the like, the post-transition metal and metalloid in Groups 13 to 15 may be, for example, Al, Ga, In, Sn, Tl, Pb, Bi, Po, B, Si, Ge, As, Sb, Te, At, or the like, and the non-metallic element in Groups 14 to 16 may be, for example, C, P, S, Se, or the like. The transition metal element may include a lanthanide group element or an actinium group element.

In one preferred example, D may include at least one selected from the group consisting of Zr, Ti, W, B, P, Al, Si, Mg, Zn, and V.

The cathode active material prepared in the experiment described later according to the present invention has a single particle with a D50 of 2 to 10 μm, an average grain size of 200 to 400 Å, a tap density of 1.8 to 2.0 g/cc, and a BET of 0.45 to 0.50 m²/g.

The present invention also provides a non-aqueous electrolyte secondary battery containing a cathode active material. The configuration and production method of the non-aqueous electrolyte secondary battery are known in the art, and thus a detailed description thereof will be omitted herein.

### Effects of the Invention

As described above, when the cathode active material satisfies the specific conditions according to the present invention during pressing in the process of manufacturing secondary batteries, it is preferably used in a non-aqueous electrolyte secondary battery that requires high pressing to realize high energy density.

### DESCRIPTION OF THE DRAWINGS

FIG. 1 is a PSD graph illustrating an exemplary cathode active material satisfying the condition that a maximum occupied volume retention rate (Z) is not less than 85% and not more than 100%;

FIG. 2 is a PSD graph illustrating an exemplary cathode active material according to the present invention having a maximum occupied volume retention (Z) of less than 85% in Equation 1;

FIG. 3 is a PSD graph illustrating an exemplary cathode active material according to the present invention having a maximum occupied volume retention (Z) greater than 100% in Equation 1;

FIG. 4 is a PSD graph illustrating an exemplary cathode active material according to the present invention having a small particle region after pressing in Equation 3; and

FIG. 5 is a graph showing a volume increase rate of secondary batteries in a high-temperature chamber over time in Experimental Example 3.

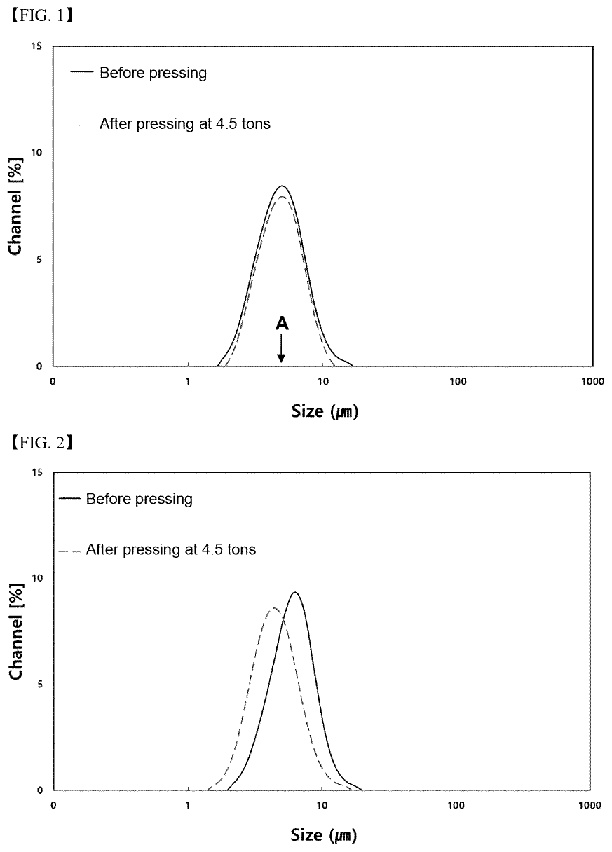

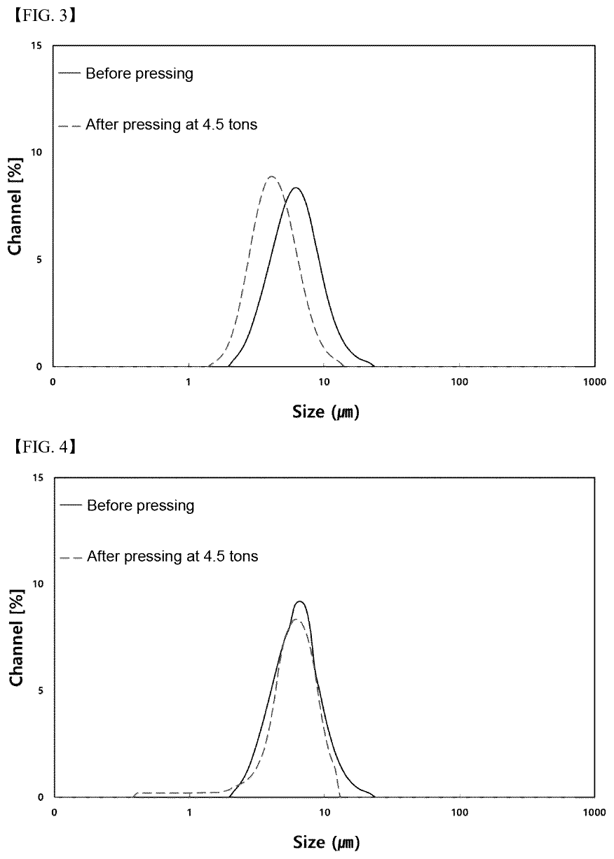

### BEST MODE

Now, the present invention will be described in more detail with reference to the following examples. These examples should not be construed as limiting the scope of the present invention.

### [Preparation Example 1] Preparation of Precursor with a Ratio of Ni, Co and Mn of 70:15:15

NiSO₄ as a nickel precursor, CoSO₄ as a cobalt precursor, and MnSO₄ as a manganese precursor were used. These raw materials were dissolved in distilled water to prepare an aqueous metal salt solution with a ratio of Ni:Co:Mn of 70:15:15 in a 2,000 L cylindrical reactor. A coprecipitation reactor was prepared and then an aqueous metal salt solution and an aqueous ammonia solution [chelating agent] were injected into the coprecipitation reactor to adjust the pH to 8 to 10 and the ammonia concentration to 3,000 to 6,000 ppm in the reactor. The temperature of the reactor was maintained at 50 to 60° C. and the reaction time was 30 hours.

After the coprecipitation reaction, the precipitate synthesized by the coprecipitation was filtered and dried at 120° C. for 24 hours to prepare a precursor, which is a raw material for synthesizing a cathode active material having a D50 of 2.0 to 4.0 μm.

### [Preparation Example 2] Preparation of Precursor with a Ratio of Ni, Co and Mn of 75:10:15

NiSO₄ as a nickel precursor, CoSO₄ as a cobalt precursor, and MnSO₄ as a manganese precursor were used. These raw materials were dissolved in distilled water to prepare an aqueous metal salt solution with a ratio of Ni:Co:Mn of 75:10:15 in a 2,000 L cylindrical reactor. A coprecipitation reactor was prepared and then an aqueous metal salt solution and an aqueous ammonia solution [chelating agent] were injected into the coprecipitation reactor to adjust the pH to 10 to 12 and the ammonia concentration to 3,000 to 6,000 ppm in the reactor. The temperature of the reactor was maintained at 60 to 70° C. and the reaction time was 25 hours.

After the coprecipitation reaction, the precipitate synthesized by the coprecipitation was filtered and dried at 120° C. for 24 hours to prepare a precursor, which is a raw material for synthesizing a cathode active material having a D50 of 2.5 to 3.5 μm.

### [Preparation Example 3] Preparation of Precursor with a Ratio of Ni, Co and Mn of 80:10:10

NiSO₄ as a nickel precursor, CoSO₄ as a cobalt precursor, and MnSO₄ as a manganese precursor were used. These raw materials were dissolved in distilled water to prepare an aqueous metal salt solution with a ratio of Ni:Co:Mn of 80:10:10 in a 2,000 L cylindrical reactor. A coprecipitation reactor was prepared and then an aqueous metal salt solution and an aqueous ammonia solution [chelating agent] were injected into the coprecipitation reactor to adjust the pH to 11 to 12 and the ammonia concentration in the reactor to 3,000 to 6,000 ppm in the reactor. The temperature of the reactor was maintained at 60 to 70° C. and the reaction time was 27 hours.

After the coprecipitation reaction, the precipitate synthesized by the coprecipitation was filtered and dried at 120° C. for 24 hours to prepare a precursor, which is a raw material for synthesizing a cathode active material having a D50 of 2.0 to 3.5 μm.

### [Preparation Example 4] Preparation of Precursor with a Ratio of Ni, Co and Mn of 90:5:5

NiSO₄ as a nickel precursor, CoSO₄ as a cobalt precursor, and MnSO₄ as a manganese precursor were used. These raw materials were dissolved in distilled water to prepare an aqueous metal salt solution with a ratio of Ni:Co:Mn of 90:5:5 in a 2,000 L cylindrical reactor. A coprecipitation reactor was prepared and then an aqueous metal salt solution and an aqueous ammonia solution [chelating agent] were injected into the coprecipitation reactor to adjust the pH to 13 to 14 and the ammonia concentration in the reactor to 3,000 to 6,000 ppm in the reactor. The temperature of the reactor was maintained at 70 to 80° C. and the reaction time was 25 hours.

After the coprecipitation reaction, the precipitate synthesized by the coprecipitation was filtered and dried at 120° C. for 24 hours to prepare a precursor, which is a raw material for synthesizing a cathode active material having a D50 of 2.0 to 4.0 μm. [Comparative Example 1] Preparation of single-diameter cathode active material under the conditions of Z<85%, Y<80%, W>10%

1.01 mole of LiOH·H₂O (SQM), 0.003 mole of Al(OH)₃, and 0.0020 mole of Co(OH)₂ based on 1 mole of the precursor obtained in Preparation Example 1 were mixed with a Henschel mixer (Nippon Coke & engineering Co., Ltd.) as a mixer at 52 Hz for 20 minutes to prepare a mixture. Then, the mixture was injected into an RHK (roller hearth kiln), calcined in the presence of oxygen at 750° C. for 10 hours, and then cooled to room temperature. Then, the calcined product was pulverized using an Air Classifying Mill (Hosokawa Micron Corporation) as pulverizing equipment to prepare a cathode active material.

### [Comparative Example 2] Preparation of Single-Diameter Cathode Active Material Under the Conditions of Z<85%, Y>80%, W>10%

1.01 mole of LiOH·H₂O (SQM), 0.003 mole of Al(OH)₃, and 0.0020 mole of Co(OH)₂ based on 1 mole of the precursor obtained in Preparation Example 1 were mixed with a Henschel mixer (Nippon Coke & engineering Co., Ltd.) as a mixer at 52 Hz for 20 minutes to prepare a mixture. Then, the mixture was injected into an RHK (roller hearth kiln), calcined in the presence of oxygen at 800° C. for 10 hours, and then cooled to room temperature. Then, the calcined product was pulverized using an air classifying mill as pulverizing equipment to prepare a cathode active material.

### [Comparative Example 3] Preparation of Single-Diameter Cathode Active Material Under the Conditions of Z<85%, Y>80%, W<10%

1.01 mole of LiOH·H₂O (SQM), 0.003 mole of Al(OH)₃, and 0.0020 mole of Co(OH)₂ based on 1 mole of the precursor obtained in Preparation Example 1 were mixed with a Henshel mixer at 52 Hz for 20 minutes to prepare a mixture. Then, the mixture was injected into an RHK (roller hearth kiln), calcined in the presence of oxygen at 800° C. for 15 hours, and then cooled to room temperature. Then, the calcined product was pulverized using an air classifying mill as pulverizing equipment to prepare a cathode active material.

### [Example 1] Preparation of Single-Diameter Cathode Active Material Under the Conditions of Z>85%, Y<80%, W<10%

1.03 mole of LiOH·H₂O (SQM), 0.003 mole of Al(OH)₃, and 0.0020 mole of Co(OH)₂ based on 1 mole of the precursor obtained in Preparation Example 1 were mixed with a Henschel mixer at 52 Hz for 20 minutes to prepare a mixture. Then, the mixture was injected into an RHK (roller hearth kiln), calcined in the presence of oxygen at 800° C. for 20 hours, and then cooled to room temperature. Then, the calcined product was pulverized using an air classifying mill as pulverizing equipment to prepare a cathode active material.

### [Example 2] Preparation of Single-Diameter Cathode Active Material Under the Conditions of Z>85%, Y<80%, W<10%

1.03 mole of LiOH·H₂O (SQM), 0.003 mole of Al(OH)₃, and 0.0020 mole of Co(OH)₂ based on 1 mole of the precursor obtained in Preparation Example 1 were mixed with a Henschel mixer at 52 Hz for 20 minutes to prepare a mixture. Then, the mixture was injected into an RHK (roller hearth kiln), calcined in the presence of oxygen at 800° C. for 30 hours, and then cooled to room temperature. Then, the calcined product was pulverized using an air classifying mill as pulverizing equipment to prepare a cathode active material.

### [Example 3] Preparation of Single-Diameter Cathode Active Material Under the Conditions of Z>85%, Y≥80%, W<10%

1.03 mole of LiOH·H₂O (SQM), 0.003 mole of Al(OH)₃, and 0.0020 mole of Co(OH)₂ based on 1 mole of the precursor obtained in Preparation Example 1 were mixed with a Henschel mixer at 52 Hz for 20 minutes to prepare a mixture. Then, the mixture was injected into an RHK (roller hearth kiln), calcined in the presence of oxygen at 850° C. for 30 hours, and then cooled to room temperature. Then, the calcined product was pulverized using an air classifying mill as pulverizing equipment to prepare a cathode active material.

### [Example 4] Preparation of Single-Diameter Cathode Active Material Under the Conditions of Z>85%, Y>80%, W<10%

1.05 mole of LiOH·H₂O (SQM), 0.003 mole of Al(OH)₃, and 0.0020 mole of Co(OH)₂ based on 1 mole of the precursor obtained in Preparation Example 2 were mixed with a Henschel mixer at 52 Hz for 20 minutes to prepare a mixture. Then, the mixture was injected into an RHK (roller hearth kiln), calcined in the presence of oxygen at 900° C. for 20 hours, and then cooled to room temperature. Then, the calcined product was pulverized using an air classifying mill as pulverizing equipment to prepare a cathode active material.

### [Example 5] Preparation of Single-Diameter Cathode Active Material Under the Conditions of Z>85%, Y>80%, W<10%

1.06 mole of LiOH·H₂O (SQM), 0.003 mole of Al(OH)₃, and 0.0020 mole of Co(OH)₂ based on 1 mole of the precursor obtained in Preparation Example 2 were mixed with a Henschel mixer at 52 Hz for 20 minutes to prepare a mixture. Then, the mixture was injected into an RHK (roller hearth kiln), calcined in the presence of oxygen at 900° C. for 30 hours, and then cooled to room temperature. Then, the calcined product was pulverized using an air classifying mill as pulverizing equipment to prepare a cathode active material.

### [Example 6] Preparation of Single-Diameter Cathode Active Material Under the Conditions of Z>85%, Y>80%, W<10%

1.06 mole of LiOH·H₂O (SQM), 0.003 mole of Al(OH)₃, and 0.0020 mole of Co(OH)₂ based on 1 mole of the precursor obtained in Preparation Example 2 were mixed with a Henschel mixer at 52 Hz for 20 minutes to prepare a mixture. Then, the mixture was injected into an RHK (roller hearth kiln), calcined in the presence of oxygen at 950° C. for 30 hours, and then cooled to room temperature. Then, the calcined product was pulverized using an air classifying mill as pulverizing equipment to prepare a cathode active material.

### [Example 7] Preparation of Single-Diameter Cathode Active Material Under the Conditions of Z>85%, Y>80%, W<10%

1.04 mole of LiOH·H₂O (SQM), 0.003 mole of Al(OH)₃, and 0.0020 mole of Co(OH)₂ based on 1 mole of the precursor obtained in Preparation Example 3 were mixed with a Henschel mixer at 52 Hz for 20 minutes to prepare a mixture. Then, the mixture was injected into an RHK (roller hearth kiln), calcined in the presence of oxygen at 900° C. for 20 hours, and then cooled to room temperature. Then, the calcined product was pulverized using an air classifying mill as pulverizing equipment to prepare a cathode active material.

### [Example 8] Preparation of Single-Diameter Cathode Active Material Under the Conditions of Z>85%, Y>80%, W<10%

1.05 mole of LiOH·H₂O (SQM), 0.003 mole of Al(OH)₃, and 0.0020 mole of Co(OH)₂ based on 1 mole of the precursor obtained in Preparation Example 3 were mixed with a Henschel mixer at 52 Hz for 20 minutes to prepare a mixture. Then, the mixture was injected into an RHK (roller hearth kiln), calcined in the presence of oxygen at 900° C. for 30 hours, and then cooled to room temperature. Then, the calcined product was pulverized using an air classifying mill as pulverizing equipment to prepare a cathode active material.

### [Example 9] Preparation of Single-Diameter Cathode Active Material Under the Conditions of Z>85%, Y>80%, W<10%

1.06 mole of LiOH·H₂O (SQM), 0.003 mole of Al(OH)₃, and 0.0020 mole of Co(OH)₂ based on 1 mole of the precursor obtained in Preparation Example 3 were mixed with a Henschel mixer at 52 Hz for 20 minutes to prepare a mixture. Then, the mixture was injected into an RHK (roller hearth kiln), calcined in the presence of oxygen at 950° C. for 30 hours, and then cooled to room temperature. Then, the calcined product was pulverized using an air classifying mill as pulverizing equipment to prepare a cathode active material.

### [Example 10] Preparation of Single-Diameter Cathode Active Material Under the Conditions of Z>85%, Y>80%, W>10%

1.04 mole of LiOH·H₂O (SQM), 0.003 mole of Al(OH)₃, and 0.0020 mole of Co(OH)₂ based on 1 mole of the precursor obtained in Preparation Example 4 were mixed with a Henschel mixer at 52 Hz for 20 minutes to prepare a mixture. Then, the mixture was injected into an RHK (roller hearth kiln), calcined in the presence of oxygen at 850° C. for 20 hours, and then cooled to room temperature. Then, the calcined product was pulverized using an air classifying mill as pulverizing equipment to prepare a cathode active material.

### [Example 11] Preparation of Single-Diameter Cathode Active Material Under the Conditions of Z>85%, Y<80%, W>10%

1.05 mole of LiOH·H₂O (SQM), 0.003 mole of Al(OH)₃, and 0.0020 mole of Co(OH)₂ based on 1 mole of the precursor obtained in Preparation Example 4 were mixed with a Henschel mixer at 52 Hz for 20 minutes to prepare a mixture. Then, the mixture was injected into an RHK (roller hearth kiln), calcined in the presence of oxygen at 850° C. for 30 hours, and then cooled to room temperature. Then, the calcined product was pulverized using an air classifying mill as pulverizing equipment to prepare a cathode active material.

### [Example 12] Preparation of Single-Diameter Cathode Active Material Under the Conditions of Z>85%, Y>80%, W<10%

1.05 mole of LiOH·H₂O (SQM), 0.003 mole of Al(OH)₃, and 0.0020 mole of Co(OH)₂ based on 1 mole of the precursor obtained in Preparation Example 4 were mixed with a Henschel mixer at 52 Hz for 20 minutes to prepare a mixture. Then, the mixture was injected into an RHK (roller hearth kiln), calcined in the presence of oxygen at 900° C. for 30 hours, and then cooled to room temperature. Then, the calcined product was pulverized using an air classifying mill as pulverizing equipment to prepare a cathode active material.

### Experimental Example 1

A pressure of 4.5 tons per unit area (cm²) was applied to the particles of the cathode active material prepared in Comparative Examples 1 to 3 and Examples 1 to 12 using Autopellet 3887NE.L (Carver). The change in particle size distribution before and after pressing was measured, and Z, Y, and W of the following Equations 1 to 3 were calculated and shown in Table 1.

$$[ Equation 1 ]$$

$$Z = ( volume \% of particles at point A after pressing / volume \% of particles at point A before pressing ) \times 100$$

$$[ Equation 2 ]$$

$$Y = ( diameter of particles having a maximum \text{} occupied volume after pressing / diameter of particles having a maximum occupied volume before pressing ) \times 100$$

$$[ Equation 3 ]$$

$$W = ( volume \% of newly observed peak in a small particle area after pressing / volume \% of particles at point A before pressing ) \times 100$$

TABLE 1

| | Z | Y | W |
|---|---|---|---|
| | (Criteria: 85% | (Criteria: 80% | (Criteria: 10% |
| | or more) | or more) | or less) |
| Comparative | 54.12% | 69.21% | 23.20% |
| Example 1 | | | |
| Comparative | 65.11% | 80.11% | 22.33% |
| Example 2 | | | |
| Comparative | 67.33% | 81.15% | 5.12% |
| Example 3 | | | |
| Example 1 | 85.14% | 64.53% | 0.82% |
| Example 2 | 85.16% | 69.33% | 0.12% |
| Example 3 | 85.18% | 81.14% | 0.02% |
| Example 4 | 85.11% | 82.11% | 0.02% |
| Example 5 | 85.22% | 83.12% | 0.01% |
| Example 6 | 90.15% | 84.32% | 0.04% |
| Example 7 | 91.45% | 88.35% | 0.06% |
| Example 8 | 92.55% | 81.36% | 0.02% |
| Example 9 | 93.17% | 87.33% | 0.04% |
| Example 10 | 93.11% | 83.33% | 22.12% |
| Example 11 | 92.11% | 64.56% | 21.00% |
| Example 12 | 90.22% | 85.11% | 0.06% |

In all of Comparative Examples 1 to 3, Z was less than 85% and did not satisfy the conditions of Equation 1. In Comparative Examples 2 and 3, only Y satisfied the conditions of Equation 2, and in Comparative Example 3, only W satisfied the conditions of Equation 3.

On the other hand, in Examples 1 to 12, Z was 85% or more and thus satisfied at least the condition of Equation 1.

Whether or not these conditions are satisfied causes differences in the performance of the secondary battery in Experimental Examples 2 and 3 described later.

### Experimental Example 2

A 2032 coin-type half-cell was manufactured using the cathode active material prepared in each of Examples 1 to 12 and Comparative Examples 1 to 3, and then electrochemical test was performed.

Specifically, the cathode active material, polyvinylidene fluoride as a binder (KF1100), and Super-P as a conductive material were mixed at a weight ratio of 8:1:1, and the mixture was mixed with N-methyl-2 pyrrolidone as a solvent to prepare a cathode active material slurry. Then, aluminum foil (Al foil, thickness: 22 μm), which is a cathode current collector, was coated with the slurry, dried at 120° C., and then pressed to prepare a cathode plate.

The loading level of the rolled cathode was 12 mg/cm² and the rolled density was 3.3 g/cm³. The cathode plate was punched to 14Φ, and a 2032 coin-type half-cell was manufactured using lithium metal as an anode and an electrolyte (EC/DMC 1:1+1 mole of LiPF₆).

The manufactured coin-type half-cell was aged at room temperature for 12 hours, and then a charge-discharge test was performed thereon.

Capacity test was based on 200 mAh/g at 0.1 C rate, and charge and discharge were performed under the conditions of constant current (CC)/constant voltage (CV) within a voltage range of 4.3 to 2.7V. 100 charge/discharge cycles were performed under current conditions of 0.5 C charge/1.0 C discharge and were tested in a high-temperature 45° C. chamber. The test results are shown in Table 2 below.

TABLE 2

| | | Lifespan resistance |
|---|---|---|
| | Lifespan retention rate | increase rate (based |
| | (based on 100 cycles) | on 100 cycles) |
| Comparative Example 1 | 70.08% | 86.12% |
| Comparative Example 2 | 71.11% | 88.33% |
| Comparative Example 3 | 69.99% | 89.34% |
| Example 1 | 81.00% | 72.45% |
| Example 2 | 83.66% | 70.10% |
| Example 3 | 87.56% | 61.16% |
| Example 4 | 89.77% | 51.42% |
| Example 5 | 91.24% | 50.33% |
| Example 6 | 92.00% | 45.12% |
| Example 7 | 92.11% | 42.33% |
| Example 8 | 93.50% | 40.12% |
| Example 9 | 93.45% | 39.58% |
| Example 10 | 90.11% | 47.36% |
| Example 11 | 89.33% | 43.66% |
| Example 12 | 93.11% | 40.12% |

In Table 2 above, “lifespan retention rate” represents a ratio of 100^{th} discharge capacity to 1^{st} discharge capacity, and “high temperature lifespan resistance (DC-IR. direct current internal resistance) increase rate” is obtained by measuring the high temperature lifespan initial resistance, measuring the resistance after 100 cycle lifespan and converting the increase rate to percentage (%).

As can be seen from the experimental results of Table 2 along with Table 1, Comparative Examples 1 to 3 do not satisfy the condition that Z (maximum occupied volume retention rate) should be at least 85%. As a result, the charge-discharge lifespan capacity after 100 cycles maintains only about 70% of the initial capacity, and the lifespan resistance increase rate is as high as 89%.

On the other hand, in Example 11, although the cathode active material satisfies the condition of Z and does not satisfy the conditions of Y (maximum occupied volume diameter retention rate) and W (small particle occupied volume increase rate), the 100^{th} cycle lifespan reaches 89% and lifespan resistance increase rate decreases to 43%, which indicates that Z (maximum occupied volume retention rate) has the greatest impact on lifespan performance.

Comparing Example 2 with Example 3, Example 2 satisfies the conditions of Z and W, and Example 3 satisfies all of the conditions of Z, Y, and W. As a result, compared to Example 2, Example 3 exhibited an about 4% improvement in lifespan characteristics and an about 10% improvement in lifespan resistance increase rate. This shows that Y (maximum occupied volume diameter retention rate) also has a significant impact on lifespan characteristics and lifespan resistance performance.

Comparing Example 10 with Example 12, Example 10 satisfies the conditions of Z and Y, and Example 12 satisfies all of the conditions of Z, Y, and W. As a result, compared to Example 10, Example 12 exhibited an about 3% improvement in lifespan characteristics and an about 7% improvement in lifespan resistance increase rate. This shows that W (small particle occupied volume increase rate) also has a significant impact on lifespan characteristics and lifespan resistance performance.

### Experimental Example 3

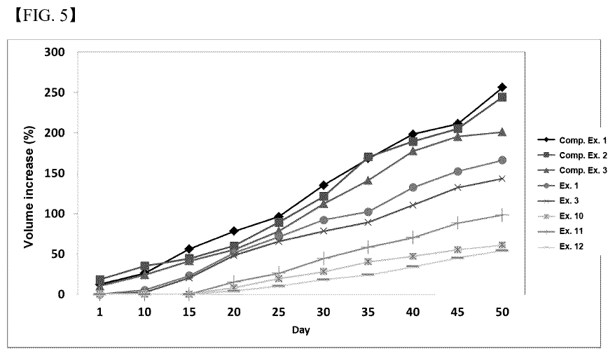

A single-plate full cell (using a graphite anode) with a predetermined size manufactured using the cathode active material prepared in each of Examples 1 to 12 and Comparative Examples 1 to 3 was charged to 4.3V at 25° C. at a constant current (CC) of 0.1 C, and was charged once at a constant voltage (CV) of 4.3V until the charging current reached a constant current of 0.05 C. Then, the cell was discharged to 3.0V at a constant current (CC) of 0.1 C. Finally, the cell was charged again to 4.3V, and then the cell was disassembled while charged at a constant voltage (CV) of 4.3V to extract the cathode plate. The extracted electrode plate was again sealed in an aluminum pouch with a predetermined size and stored in a high temperature chamber at 60° C., and the increase in pouch volume was measured by day. The results are shown in Table 3 and FIG. 5 below.

TABLE 3

| | Gas measurement date (volume increase %) | | | | | |
|---|---|---|---|---|---|---|
| | 1 | 10 | 20 | 30 | 40 | 50 |
| Comparative Example 1 | 12 | 26 | 78 | 135 | 198 | 256 |
| Comparative Example 2 | 18 | 35 | 60 | 121 | 189 | 244 |
| Comparative Example 3 | 10 | 24 | 55 | 112 | 177 | 201 |
| Example 1 | 0 | 5 | 51 | 92 | 132 | 166 |
| Example 2 | 0 | 4 | 49 | 88 | 123 | 154 |
| Example 3 | 0 | 2 | 48 | 78 | 110 | 143 |
| Example 4 | 0 | 0 | 5 | 21 | 45 | 62 |
| Example 5 | 0 | 0 | 4 | 19 | 39 | 55 |
| Example 6 | 0 | 0 | 3 | 17 | 37 | 52 |
| Example 7 | 0 | 0 | 4 | 15 | 30 | 49 |
| Example 8 | 0 | 0 | 2 | 15 | 35 | 48 |
| Example 9 | 0 | 0 | 2 | 14 | 32 | 47 |
| Example 10 | 0 | 0 | 8 | 28 | 47 | 61 |
| Example 11 | 0 | 0 | 15 | 44 | 70 | 98 |
| Example 12 | 0 | 0 | 4 | 18 | 34 | 54 |

As can be seen from Table 2 and FIG. 5, among Comparative Examples and Examples, Comparative Example 1, which did not satisfy all of the conditions of Z, Y, and W, exhibited the most gas generation. As Z (maximum occupied volume retention rate) became close to 100%, gas generation tended to decrease significantly. Thereamong, Example 12, which satisfies all of the conditions of Z, Y, and W, exhibited the least gas generation, and Example 10, which satisfies the conditions of Z and Y, and Example 11, which satisfies only the conditions of Z, decreased in gas generation in this order.

This behavior is similar to the electrochemical test results described with reference to Table 2. That is, when all the conditions of Z (maximum occupied volume retention rate), Y (maximum occupied volume diameter retention rate), and W (small-particle occupied volume increase rate) are satisfied, the performance of the cathode active material for lithium secondary batteries is significantly improved.

Although preferred embodiments of the present invention have been disclosed for illustrative purposes, those skilled in the art will appreciate that various modifications, additions, and substitutions are possible without departing from the scope and spirit of the invention as disclosed in the accompanying claims.

1. A cathode active material for a non-aqueous electrolyte secondary battery,
wherein, when comparing volume versus particle size distribution (PSD) graphs before and after pressing under the following pressing condition, the condition of the following Equation 1 is satisfied at point A corresponding to a diameter of particles having a maximum occupied volume before pressing on an X-axis of the graph.
$$[ Equation 1 ]$$
$$Z = ( volume \% of particles at point A after pressing / volume \% of particles at point A before pressing ) \times 100$$
$$Z \geq 85 \%$$
[Pressing condition]
The active material is pressed at 4.5 tons per unit area (cm²).

2. The cathode active material according to claim 1, wherein the cathode active material comprises unaggregated one-body particles.

3. The cathode active material according to claim 1, wherein the cathode active material satisfies the condition of Equation 2 below.
$$[ Equation 2 ]$$
$$Y = ( diameter of particles having a maximum \text{} occupied volume after pressing / diameter of particles having a maximum occupied volume before pressing ) \times 100$$
$$Y \geq 80 \%$$

4. The cathode active material according to claim 1, wherein the cathode active material satisfies the condition of Equation 3 below.
$$[ Equation 3 ]$$
$$W = ( volume \% of newly observed peak in a small particle area after pressing / volume \% of particles at point A before pressing ) \times 100$$
$$W \leq 10 \%$$
wherein the small particle area is an area where a particle diameter is 1 μm or less.

5. The cathode active material according to claim 2, wherein the cathode active material has an average particle diameter (D50) of 2 to 10 μm.

6. The cathode active material according to claim 1, wherein the cathode active material has a non-aggregated one-body particle structure, and Z in Equation 1 is 90% or more.

7. The cathode active material according to claim 3, wherein the cathode active material has a non-aggregated one-body particle structure, and Y in Equation 2 is 90% or more.

8. The cathode active material according to claim 4, wherein the cathode active material has a non-aggregated one-body particle structure, and W in Equation 3 is 5% or less.

9. The cathode active material according to claim 1, wherein the cathode active material is represented by the following Formula (4).
LiₐM_{b}DₑOₓ (4)
wherein
M includes at least one of Ni, Co, and Mn,
D includes at least one selected from alkali metals excluding lithium, alkaline earth metals, transition metals in Groups 3 to 12 excluding nickel, cobalt and manganese, post-transition metals and metalloids in Groups 13 to 15, and non-metallic elements in Groups 14 to 16, and
a, b, c and x satisfy 0.9≤a≤2.0, 0<b≤1, 0≤c≤0.5, and 0<x≤8, respectively.

10. The cathode active material according to claim 9, wherein the cathode active material has an average grain size of 200 to 400 Å.

11. The cathode active material according to claim 9, wherein the cathode active material has a tab density of 1.8 to 2.0 g/cc.

12. The cathode active material according to claim 9, wherein the cathode active material has a BET of 0.45 to 0.50 m²/g.

13. A non-aqueous electrolyte secondary battery comprising the cathode active material according to claim 1.
